(19) United States
(12) Patent Application Publication
(10) Pub. No.: US 2006/0146651 A1
(43) Pub. Date: Jul. 6, 2006

(54) Method for encoding a date for universal recognition

(76) Inventors: Chan J. Park, Glenn Dale, MD (US); Christine Y. Park, Glenn Dale, MD (US); Seo W. Park, Glenn Dale, MD (US)

Correspondence Address: LITMAN LAW OFFICES, LTD, PO BOX 15035, CRYSTAL CITY STATION, ARLINGTON, VA, 22215, US

(21) Appl. No.: 11/025,250

(22) Filed: Dec. 30, 2004

(51) Int. Cl. G04C 17/00; G04B 19/24

(52) U.S. Cl. 368/29

(57) ABSTRACT

The method for encoding a date for universal recognition provides a representation of a date that eliminates ambiguities that may arise because of different date formats widely used throughout the world. A date is encoded by first expressing the date as at least a calendar month and a calendar year within a calendar system. A month identifier is encoded for the calendar month. The month identifier comprises a first identifier field having a first association with the name of the month, and a second identifier field having a second association with the name of the month. Next, a year identifier is formed for the calendar year. A date representation is formed by formatting the month identifier together with the year identifier. Visual indicia of the date representation are formed on an article to express a date of interest, such as an expiration date on a credit card.

### BACKGROUND OF THE INVENTION

1. Field of the Invention

The present invention relates to a method for visually expressing a date, and more particularly, to a method for encoding a date for universal recognition.

2. Description of the Related Art

A calendar date is a reference to a particular day in a calendar system. Calendars have been employed for millennia to define, and to track, the passage of time. Often based on the perceived motion of an astronomical object, such as the sun or the moon, or other heavenly bodies, calendar systems have been devised to track the passage of seasons, to mark or record significant events such as religious or state celebrations, to mark or record other events, and simply to measure the passage of time.

Throughout the ages, different calendars have come into usage. Solar calendars, such as the Persian calendar devised around the eleventh century, are based on seasonal changes and are synchronized to the perceived motion of the sun (or, more properly, the motion of the Earth about the sun). Lunar calendars, such as the Islamic calendar, are based on the motion of the Moon. In a lunisolar calendar system, the calendar is synchronized to both the sun and the moon. An example of a lunisolar calendar is the Jewish calendar.

The Julian calendar was adopted under the Roman Empire. The Julian calendar is a solar calendar, having months that are longer than the lunar cycle. The Julian calendar functions well to track the seasons, but is not convenient for tracking phases of the moon since the months don't synchronize with the lunar cycle. The Julian calendar year has three hundred and sixty five (365) days, except each fourth year that is a leap year having three hundred and sixty six (366) days. It can be recognized that the Julian calendar is similar to the Gregorian calendar that has become the dominant calendar for most of the Western world. The Gregorian calendar represents essentially a refinement to the Julian calendar, adjusted to more closely synchronize with seasonal changes.

The evolution and use of calendar systems has followed, to a degree, various and distinct cultures throughout history. Obvious examples are the Gregorian, Islamic, and Jewish calendars. While the Gregorian calendar has become predominant in Western societies, numerous others remain currently in use throughout the world. Thus, a date expressed according to one calendar may not be relevant or meaningful according to another. While the adoption of a single calendar standard for international business and other purposes is helpful, it can be understood that the historical evolution of numerous different calendars among numerous different cultures, along with simply differing cultural preferences, has led to different ways to identify dates used in various cultures throughout the world.

While reconciling dates among various different calendar systems obviously presents a problem, an additional problem is created when different formats are used to express a date even within the same calendar system. A calendar date, being a reference to a particular day in a particular calendar system, generally identifies the month, the day of the month, and the year of the calendar date.

Even within a single calendar system, different formats are used to express a calendar date. In the Gregorian calendar system, different formats are widely used. Various formats are shown in Table 1, each identifying the 22nd day of November, 2004:

TABLE 1

November 22, 2004
Nov. 22, 2004
11/22/2004
11/22/04
22 November 2004
22-11-2004
22-11-04
2004-11-22

Three predominant formats are based on the ordering of day, month, and year identifiers. A first format is expressed in a month/day/year (m/d/y) ordering. A second format uses an ordering of day/month/year (d/m/y). A third format is expressed a date in the order of year/month/day (y/m/d). Note also that each of these predominant formats may express the year in a two-digit format (for example, using “04” as an abbreviation referring to the year 2004) or a four-digit format. These formats are used throughout the world, generally as indicated in Table 2:

TABLE 2

| d/m/y | m/d/y | y/m/d |
|---|---|---|
| Australia | United States | Albania |
| Austria | Philippines | Canada (French) |
| Belgium | UK | China |
| Brazil | | Hong Kong (Chinese) |
| Bulgaria | | Hungary |
| Canada | | Japan |
| Czech Republic | | Korea |
| Denmark | | Latvia |
| Finland | | Lithuania |
| France | | Poland |
| Germany | | Portugal |
| Hong Kong (English) | | Sweden |
| Italy | | Taiwan |
| Netherlands | | |
| New Zealand | | |
| Norway | | |
| Romania | | |
| Slovenia | | |
| Spain | | |
| Singapore | | |
| Switzerland | | |
| UK | | |

Of course, while Table 2 indicates general usage for date formats, even within the countries identified there is often not a strict or absolute adherence to a single format or standard.

In addition to the positional placement of the day, month, and year identifiers in a date expression, different delimiters are used to separate the day, month, and year identifiers. Date expressions may be delimited as “Nov. 11, 2004”, “Nov. 16, 2004” and “Nov. 16, 2004”.

Because of the various formats that are used to indicate a date, even wherein the same calendar system is used, some ambiguity arises in the expression of a date. The degree of ambigutiy increases when a date expression is used multi-culturally, such as on travel documents, on personal identification documents, or in financial documents. It can be recognized that, especially with the use of a two-digit year representation, a date expressed as “Mar. 4, 2005” may refer to Mar. 4th, 2005 according to a m/d/y format, Apr. 3rd, 2005 according to a d/m/y format, and Apr. 5th, 2003 according to a y/m/d format.

In an abreviated notation, certain events or dates are expressed by reference solely to a month and a year. For example, a credit card expiration date is typically expressed by reference to a month and year of expiration of the card, with an understanding that the card expires on the last day of the indicated month. Thus, a degree of ambiguity in the expression of a credit card expiration date may be eliminated by simply eliminating a reference to the day. However, ambiguity remains if the year is expressed in a two-digit format. A date expressed as 03/04 may refer to either of March, 2004, or April, 2003.

Thus a method for encoding a date for universal recognition solving the aforementioned problems is desired.

### SUMMARY OF THE INVENTION

The method for encoding a date for universal recognition provides an unambiguous representation of a date in a month/year format, using a two-digit year abbreviation and a novel encoding of the month that eliminates confusion between the month and year fields. The month encoding is also useful in a format expressing day, month, and year together. In a format expressing day, month, and year together, ambiguity of the meaning of the fields is entirely eliminated if a four-digit year representation is used.

A month within a calendar system is encoded by assigning a first identifier and a second identifier associated with the month. The first identifier is a letter associated with the name of the month. The second identifier is a number associated with the ordinal position of the month within a year in the calendar system. The first and second identifiers are grouped together to form a month identifier.

The month identifier, together with the year, are imprinted together on an article wherein an unambiguous date representation desired. For example, a credit card typically bears a visual indicia of the card's expiration date. The expiration date is typically presented in a month/year date representation. Thus, a traditional representation of credit card expiration date, in a month/year including a number for the month and a two-digit number for the year, is ambiguous with respect to the various date formats encountered throughout the world. Employing a date representation using the encoding according to the present invention, the credit card expiration date may be unambiguously represented.

These and other features of the present invention will become readily apparent upon further review of the following specification and drawings.

### BRIEF DESCRIPTION OF THE DRAWINGS

FIG. 1 is a plan view of a credit card bearing visual indicia of an expiration date in a format of a method for encoding a date for universal recognition according to the present invention.

FIG. 2 is a table showing month names in the English, Latin, Russian, and German languages.

FIG. 3 is a table showing a mapping of months to an encoded month indicator according to the present invention.

FIG. 4A shows a month/year format for indicating a date, wherein the year is indicated in a two-digit format.

FIG. 4B shows a month/year format for indicating a date, wherein the year is indicated in a four-digit format.

FIG. 4C shows a day/month/year format for indicating a date, wherein the year is indicated in a four-digit format.

Similar reference characters denote corresponding features consistently throughout the attached drawings.

### DETAILED DESCRIPTION OF THE PREFERRED EMBODIMENTS

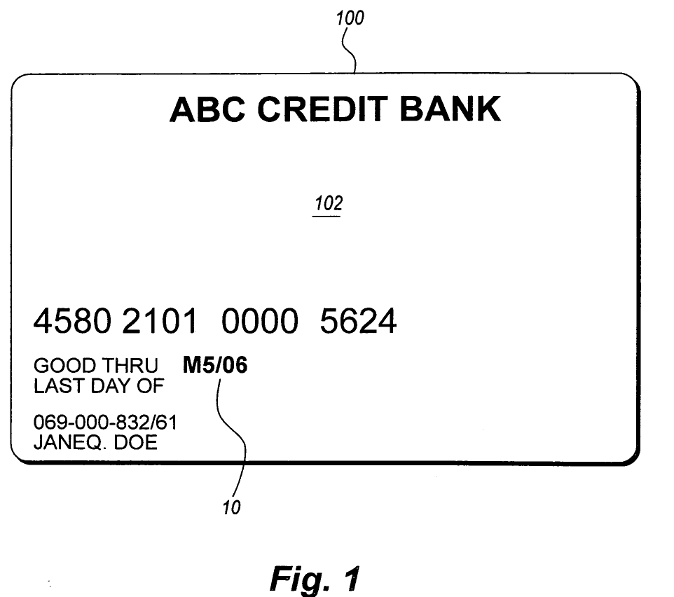

The present invention is a method for encoding a date for universal recognition. A visual representation of a date, encoded according to the method of the present invention, is disposed on an article where a date must be unambiguously expressed. An example of such an article is a personally carried card such as an identification card, drivers license, credit card, or the like wherein one or more dates must be visually expressed on the card such as a birth date, expiration date or any other date. Referring to FIG. 1, a credit card 100 is shown bearing a date representation 10 in an unambiguous format according to the method for encoding a date for universal recognition, the date representation 100 disposed on the face 102 of the credit card 100.

A date is generally expressed by reference to a day, a month, and a year within a calendar system. The day is a day within a month, and the month is a named month or interval within a year as defined by the calendar system. A month within a calendar system may be identified by it's name (January, February, March, and so forth in the Gregorian calendar system), or by it's ordinal position within a calendar year of the calendar system (January, the first month in a calendar year in the Gregorian calendar is represented as 1 or 01; February, the second month, as 2 or 02, and so forth).

The date format according to the method for encoding a date for universal recognition encodes the month in a calendar date using a pair of identifiers, each of the identifiers having an independent relationship with the month. According to the illustrated embodiment, months of the Gregorian calendar system are encoded.

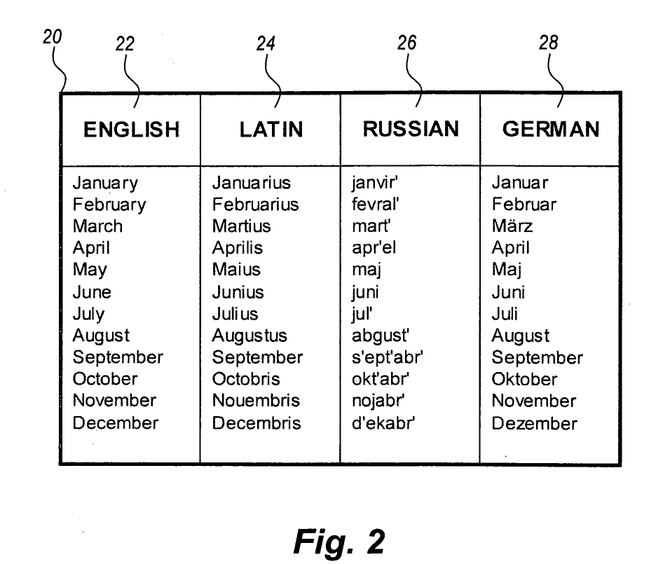

Turning to FIG. 2, it can be noted that the names of the months in the Gregorian calendar remain similar across several disparate languages. A table 20, shown in FIG. 2, shows the Gregorian calendar month names in English 22, Latin 24, Russian 26, and German 28. While the month names are similar in the different languages, it is recognized, more importantly, that the first letter of each month name is common across each of the languages. That is, January (English), Januarius (Latin), janvir´ (Russian), and Januar (German) each begin with the letter “J”; February (English), Februarius (Latin), fevral´ (Russian), and Febrau (German) each begin with the letter “F”, and so forth. Note that Latin is included in the table as a proxy for several languages (including Spanish, Portuguese, French, Italian and Romanian, often referred to as the “romance languages”,) derived from Latin. Similarities in the month names are repeated among the romance languages.

The first letter of each month name, therefore, provides an identifier having an association to the month name that is common, and identifiable, to numerous languages. However, the first letter of the month names is, by itself, insufficient to unambiguously identify a month, since several month names begin with the same letter. January, June, and July each begin with “J”. March, and May each begin with “M”, and April and August each begin with “A”. Thus, while the first letter of a month name is useful to distinguish and identify a month name broadly across numerous languages, it fails on its own because of the repeated use of these letters. An additional identifier must be used to remove this ambiguity.

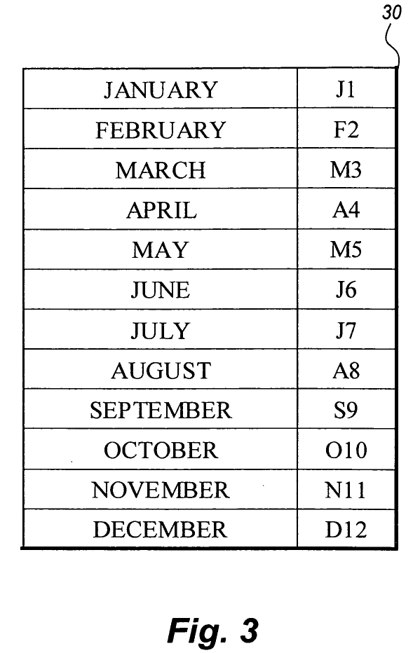

While the ordinal position of a month within a year may be ambiguous with respect to other numeric fields in a date representation 10, the ordinal position of a month is useful to eliminate the ambiguity of the first letter of a month name. Thus, an unambiguous identifier for a month in a calendar system includes a pair of identifiers, each of the identifiers having an independent relationship with the month. In the illustrated embodiment, a first identifier is the first letter of the month name. A second identifier is the ordinal position of the month within a year in the calendar system. Referring to FIG. 3, a table 30 shows the resulting encoded month identifier for each of the months in the Gregorian calendar.

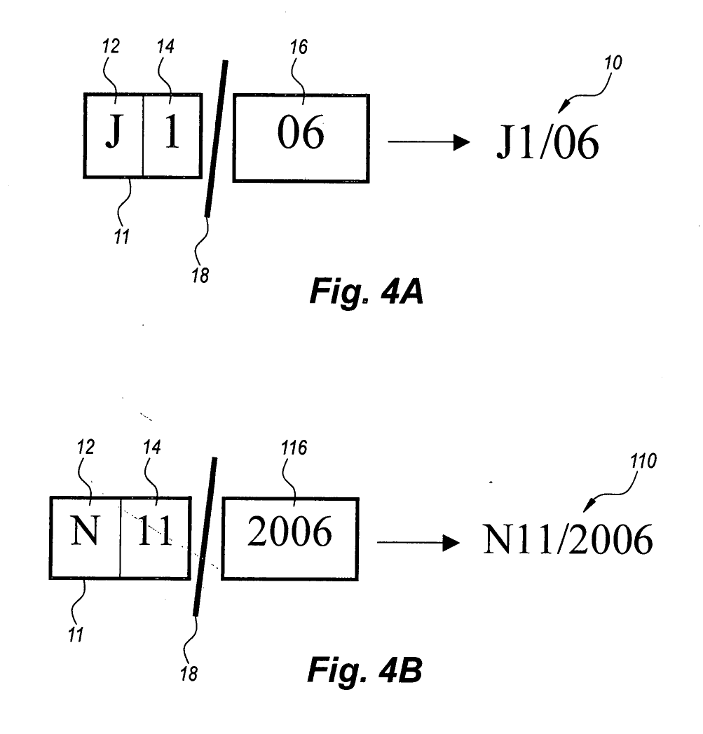

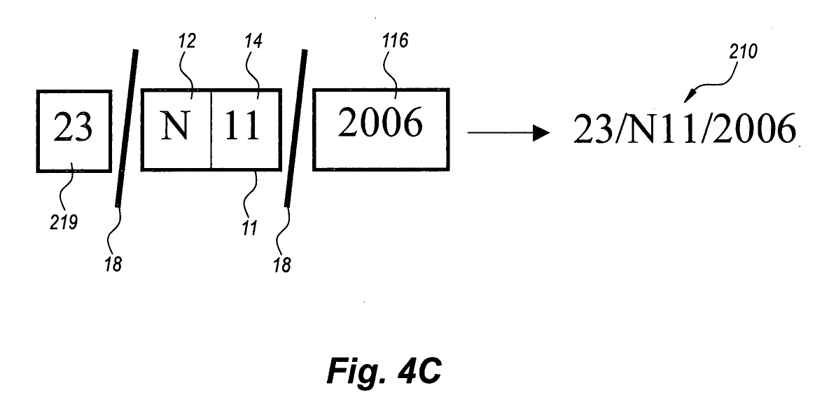

Turning now to FIG. 4A, a date representation 10 is shown in a month/year format, having a month identifier 11 and a two-digit year identifier 16. The month identifier is formatted ahead of the year identifier 16, and the month identifier 11 and year identifier 16 are separated by a delimiter 18. The month identifier 11 includes a first identifier field 12 and a seond identifier field 14. According to the method for encoding a date for universal recognition, a date is encoded for universal recognition by formatting the month as described above, setting the first identifier field 12 according to the first letter of the name of the month and setting the second identifier field 14 according to the ordinal position of the month within a year in the Gregorian calendar system. The year identifier 16 is set to a two-digit abbreviation for the year, using the last two digits of the year. In the example illustrated by FIG. 4A, the month of January, 2006 is encoded and formatted as J1/06.

Turning to FIG. 4B, a similar date representation 110 is shown in a month/year format, having a month identifier 11 and a four-digit year identifier 116. The month identifier 11 is encoded and formatted as described above, but the year identifier 116 is set to a full four-digit representation of the year. In the example illustrated by FIG. 4B, the month of November, 2006 is encoded a nd formatted as N11/2006.

Turning now to FIG. 4C, a date representation 210 is shown in a day/month/year format, having a day identifier 219, a month identifier 11 and a four-digit year identifier 116. The month identifier 11 is encoded and formatted as described above, and the year identifier 116 is set to a full four-digit representation of the year. Additionally, a day identifier 219 is set to the day of the month for the date to be expressed, and is formatted ahead of the month identifier 11 and separated from the month identifier 11 by a delimiter 18. In the example illustrated by FIG. 4C, the date of Nov. 23, 2006 is encoded and formatted as 23/N11/2006.

It is to be understood that the present invention is not limited to the embodiments described above, but encompasses any and all embodiments within the scope of the following claims.

We claim:

1. A method for encoding a date for universal recognition, the method comprising the steps of:
expressing said date as at least a calendar month and a calendar year within a calendar system;
encoding a month identifier for said calendar month wherein the month identifier comprises a first identifier field having a first association with the name of said month and a second identifier field having a second association with the name of said month;
forming a year identifier for said calendar year;
forming a date representation by formatting said month identifier together with said year identifier; and
forming visual indicia of said date representation on an article.

2. The method of claim 1, wherein said first identifier is a letter having an association with the name of said calendar month.

3. The method of claim 2, wherein said letter is associated with the first letter of the name of said calendar month.

4. The method of claim 3, wherein said letter is the first letter of the name of said calendar month.

5. The method of claim 1, wherein said second identifier is a number having an association with the name of said calendar month.

6. The method of claim 5, wherein said second identifier is a number having an association with the ordinal position of said calendar month in a calendar year according to said calendar system.

7. The method of claim 6, wherein said second identifier is the ordinal position of said calendar month in a calendar year according to said calendar system.

8. The method of claim 1, wherein said calendar system is the Gregorian calendar system.

9. The method of claim 1, wherein said article is a personally carried card.

10. The method of claim 9, wherein said personally carried card is a credit card.

11. The method of claim 10, wherein said date is the expiration date of said credit card.

12. A method for encoding a date for universal recognition, the method comprising the steps of:
expressing said date as a calendar month and a calendar year within a calendar system;
encoding a month identifier for said calendar month wherein the month identifier comprises a letter that is associated with the first letter of the name of said calendar month and a number having an association with the ordinal position of said calendar month in a calendar year according to said calendar system;
forming a year identifier for said calendar year;
forming a date representation by formatting said month identifier together with said year identifier; and
forming visual indicia of said date representation on an article.

13. The method of claim 12, wherein said letter is the first letter of the name of said calendar month.

14. The method of claim 12, wherein said number is the ordinal position of said calendar month in a calendar year according to said calendar system.

15. The method of claim 12, wherein said calendar system is the Gregorian calendar system.

16. The method of claim 12, wherein said article is a personally carried card.

17. The method of claim 16, wherein said personally carried card is a credit card.

18. The method of claim 17, wherein said date is the expiration date of said credit card.

19. A method for encoding a date for universal recognition, the method comprising the steps of:
expressing said date as a calendar month and a calendar year within the Gregorian calendar system;
encoding a month identifier for said calendar month wherein the month identifier comprises a letter that is the first letter of the name of said calendar month and a number that is the ordinal position of said calendar month in a calendar year according to said calendar system;
forming a year identifier for said calendar year;
forming a date representation by formatting said month identifier together with said year identifier; and
forming visual indicia of said date representation on an article.

20. The method of claim 19, wherein said month identifier is J1 for January, F2 for February, M3 for march, A4 for April, M5 for May, J6 for June, J7 for July, A8 for August, S9 for September, O10 for October, N11 for November, and D12 for December.
